(19) United States
(12) Patent Application Publication
(10) Pub. No.: US 2010/0174519 A1
(43) Pub. Date: Jul. 8, 2010

(54) Virtual Platform and Related Simulation Method

(76) Inventor: Yong-Hua Bu, SuZhou (CN)

Correspondence Address: NORTH AMERICA INTELLECTUAL PROPERTY CORPORATION, P.O. BOX 506, MERRIFIELD, VA, 22116, US

(21) Appl. No.: 12/646,945

(22) Filed: Dec. 23, 2009

(30) Foreign Application Priority Data
Jan. 8, 2009 (TW) 098100468

(51) Int. Cl. G06G 7/62

(52) U.S. Cl. 703/14

(57) ABSTRACT

A platform for simulating a chip includes a component module, a configuration module and a top module. The component module is utilized for storing a plurality of component models and information related to the plurality of component models. The configuration module is utilized for generating a configuration result according to the component model needed by the chip. The top module is coupled to the component module and the configuration module, for reading information related to the component model from the component module according to the configuration result, so as to simulate the chip.

### BACKGROUND OF THE INVENTION

1. Field of the Invention

The present invention is related to a virtual platform and related simulation method, and more particularly, to a virtual platform and related simulation method for simulating a chip.

2. Description of the Prior Art

With the development of semiconductor technology, the industry makes efforts in integrating a system into a chip. Therefore, a system-on-chip (SOC) has been a trend.

When designing SOC, the prior art establishes a virtual platform, to simulate SOC by software, such that a designer can recognize design errors, if any, to increase design efficiency. There are various designs for the virtual platform. For example, some virtual platforms provide graphical user interfaces (GUI) to be operated by drag & drop. However, in the prior art, adding new components is complicated in the virtual platforms, and the user has to re-edit and re-connect the whole system after adding a new component. As a result, the virtual platforms in the prior art are inconvenient for the user and take more time on designing.

### SUMMARY OF THE INVENTION

It is therefore a primary objective of the claimed invention to provide a configurable and extendable virtual platform

The present invention discloses a platform for simulating a chip, which comprises a component module, for storing a plurality of component models and information related to the plurality of component models, a configuration module, for generating a configuration result according to the component model needed by the chip, and a top module, coupled to the component module and the configuration module, for reading information related to the component model from the component module according to the configuration result, so as to simulate the chip.

The present invention further discloses a method for simulating a chip, which comprises establishing a plurality of component models and information related to the plurality of component models, generating a configuration result according to the component model needed by the chip, and reading information related to the component model from the plurality of component models according to the configuration result, so as to simulate the chip.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a virtual platform according to an embodiment of the present invention.

FIG. 2 is a schematic diagram of a system-on-chip according to an embodiment of the present invention.

FIG. 3 is a schematic diagram of establishing a component model with classes of C++ according to an embodiment of the present invention.

FIG. 4 is a schematic diagram of a process of a method for simulating a system-on-chip.

### DETAILED DESCRIPTION

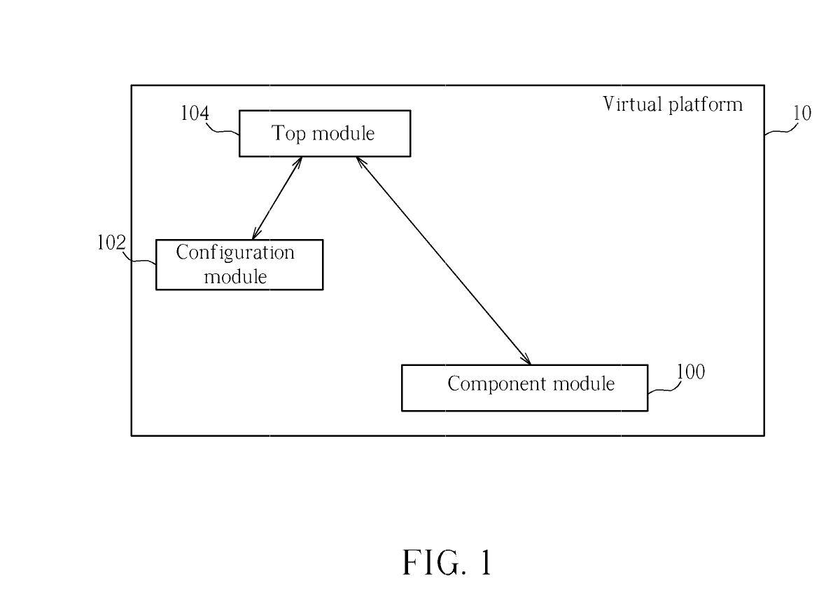

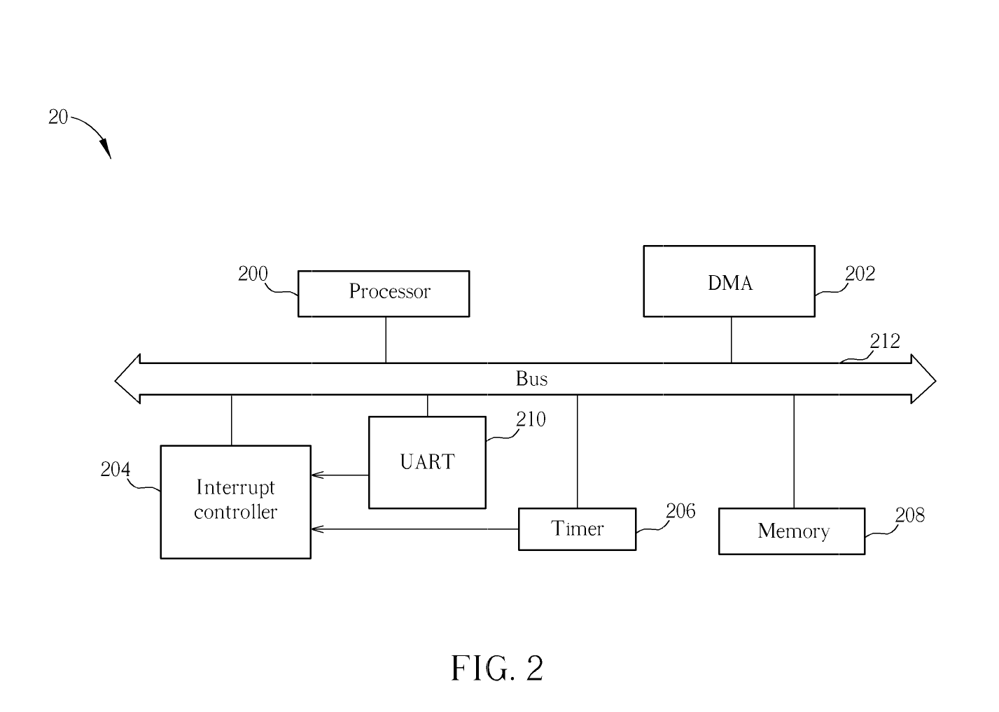

Please refer to FIG. 1, which is a schematic diagram of a virtual platform 10 according to an embodiment of the present invention. The virtual platform 10 is implemented with languages such as C++ or System C, and comprises a component module 100, a configuration module 102 and a top module 104. According to an embodiment of the present invention, the virtual platform 10 can be utilized for simulating a system-on-chip (SOC) 20 as illustrated in FIG. 2. The component module 100 comprises a plurality of component models and information related to the plurality of component models, such as names and connecting methods of the component models. The configuration module 102 is utilized for generating a configuration result according to a component model needed by SOC 20. According to the configuration result generated by the configuration module 102, the top module 104 reads information related to the component model needed by SOC 20 from the component module 100, so as to simulate an instance of the component model, and to perform related connection.

Therefore, a user can perform an appropriate configuration in the configuration module 102 according to the component model needed by SOC 20, and then the top module 104 can simulate SOC 20 according to the configuration of the configuration module 102. Take SOC 20 illustrated in FIG. 2 as an example. SOC 20 comprises a processor 200, a direct memory access (DMA) 202, an interrupt controller 204, a timer 206, a memory 208, a universal asynchronous receiver/transmitter (UART) 210 and a bus 212. In order to simulate SOC 20, in the component module 100 of the virtual platform 10, the present invention accordingly establishes component models corresponding to the components of SOC 20 for the top module 104 to simulate SOC 20.

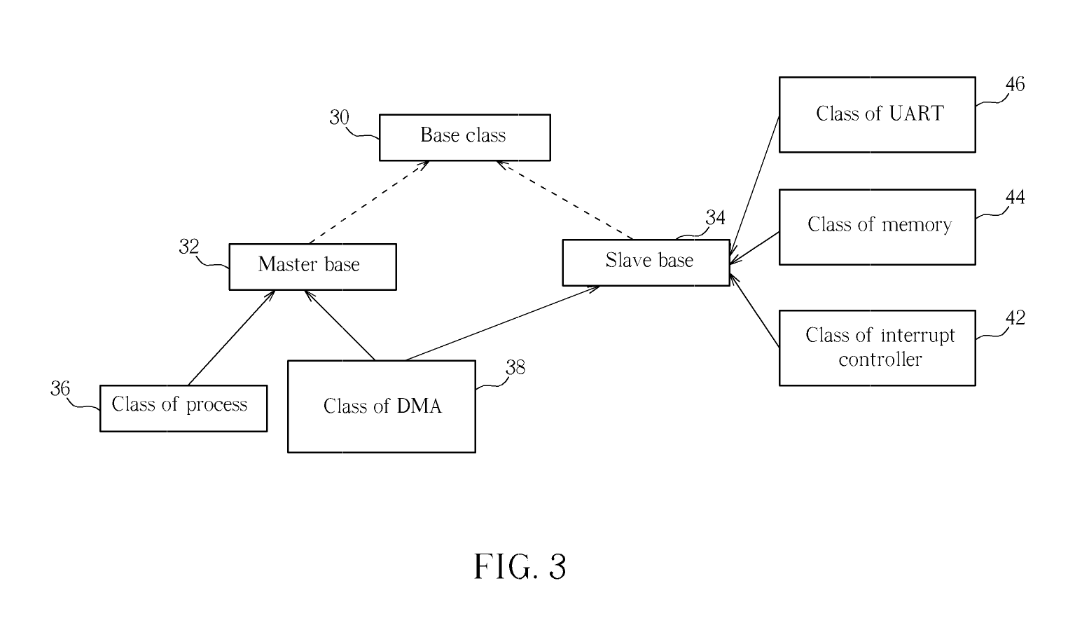

Please refer to FIG. 3, which is a schematic diagram of establishing component models with classes of C++ according to an embodiment of the present invention. In the component module 100, the component models are built with classes of C++. First, the present invention defines a base class 30. All classes of the component models are derived from the base class 30. In this embodiment, a master base 32 and a slave base 34 are derived from the base class 30. The master base 32 comprises component models 36, 38 corresponding to the processor 200 and DMA 202 of SOC 20 respectively, and the slave base 34 comprises component models 42, 44, 46 corresponding to the interrupt controller 204, the timer 206, the memory 208 and UART 210. In addition, since DMA 202 is both included in the master base 32 and the slave base 34, the component model 38 corresponding to DMA 202 is derived from the master base 32 and the slave base 34 at the same time. In such a manner, the present invention can easily manage the component models by establishing the component models with classes of C++.

A detailed description of establishing the component models in the present invention is given hereafter. Using C++ to build the base class 30 is shown as follows:

class platform_base
{

virtual void connect(map_module_t&modules)=0;
virtual void set_common_flag( )=0;
......
virtual~platform_base( ){ }

}

The function connect( ) is utilized for defining a related connecting method of the component model, such as connections with other component models. And, the master base 32 derived from the base class 30 can be represented as follows:

class platform_master_base:public virtual platform_base
{

......

}

Since the component module 100 is extendable, if there is a new-added component model corresponding to the timer 206, the component model can be defined by a file timer.h:

class timer: public platform_slave_base
{

public:

timer(const string module_name,const string config_file);
void connect(map_module_t&modules);
...... other timer specific functions ......

}

When establishing the function timer( ) except a name “module_name” assigned while generating an instance of the component model, a name “config_file” is assigned to a configuration file of the component model. The function connect( ) defines the related connecting method of the component model, and can be defined by another file timer.cpp:

void timer::connect(map_module_t&modules)
{

...... the connection procedure ......

}

As a result, the component model of the new-added timer 206 is established. The new component model is compiled as a dynamic library file and is stored in a specified directory. When operations start, the top module 104 reads the dynamic library file in the specified directory, to obtain the new component model, and generates the instance of the new component model by dynamically loading. In the present invention, dynamic loading is OS dependent. The model instance creation is completed by a maker function, defined in timer.cpp:

static platform_base* maker_timer(const char *name, const string

config_file)

{

return new timer(name, config_file);

}

However, some operating systems do not support C++ dynamic loading. Therefore, the present invention further indicates the top module 104 the existence of the maker function with C language, which can be defined in timer.cpp as follows:

extern “C”
{

void register_makers( )
{

module_makers[ “Timer” ]=maker_timer;

}

}

As shown above, when adding a new component model, the present invention only needs to compile the component model into a dynamic library file and store the component model in a specified directory. The top module 104 reads the dynamic library file in the specified directory, to obtain the new component model, and generates an instance of the new component model by dynamically loading. As a result, the present can extend the component model in the component module 100 according to different requirements, and modifies the configuration in the configuration module 102, to generate different virtual platforms 10.

When extending the component model corresponding to the timer 206, the present invention can first modify a global configuration file in the top module 102:

#define INSTANCE “Timer::Timer_0”

Timer represents a type of the component model as defined in the function register_makers. Timer_0 represents a name of the instance of the component model.

Installation of the timer 206 in the bus 212 is defined by a configuration file of the bus 212:

| #define MODULE_NAME | “SharedBus” | |
|---|---|---|
| ...... | | |
| #define BUS_SLAVE_2 | “Timer_0” | // Fully qualified |

name

| | | |
|---|---|---|
| #define SLAVE_BASE | 0x1D012300 | // physical base |

address

| | |
|---|---|
| #define SLAVE_TOP | 0x1D0123AF |
| ...... | |
| #define MODULE_END | |

Timer_0 is the instance of the component model corresponding to the new-added timer 206, installed in a slave port NO. 2 of “SharedBus”; meanwhile, information of the projected addresses of the instance is defined in the configuration file. In addition, the component model Timer_0 corresponding to the new-added timer 206 includes its own configuration file as shown below:

| | |
|---|---|
| #define MODULE_NAME | “Timer_0” |

| | | |
|---|---|---|
| #define TIMER_READ_DELAY | 2 | // read delay bus cycle. |

(multiple system clock)

| | | |
|---|---|---|
| #define TIMER_WRITE_DELAY | 3 | // write delay bus cycle. |

| | | |
|---|---|---|
| #define INT_DESTINATION | “MIPS_0” | // to which module to |

connect interrupt port

| | | |
|---|---|---|
| #define IRQ_NUM | 3 | // IRQ number |

#define MODULE_END

Here defines a two-cycle delay of reading a register by Timer_0, and an interrupt of Timer_0 should be connected to a component model instance named “MIPS_0”.

Therefore, in the present invention, when the user establishes a new virtual platform 10, the user only needs to configure related configurations in the configuration module 102 (configurable), such that the top module 104 can generate the virtual platform 10 required by the user. If there is a new component module needed by the new-generated virtual platform 10, the present invention can generate a new component model in the component module 100 (extendable) according to the aforementioned method, and then configure related configurations in the configuration module 102, such that the top module 104 can re-generate the virtual platform 10 required by the user. That is, the present invention achieves configurable and extendable features by a combination of the configuration module 102 and the component module 100.

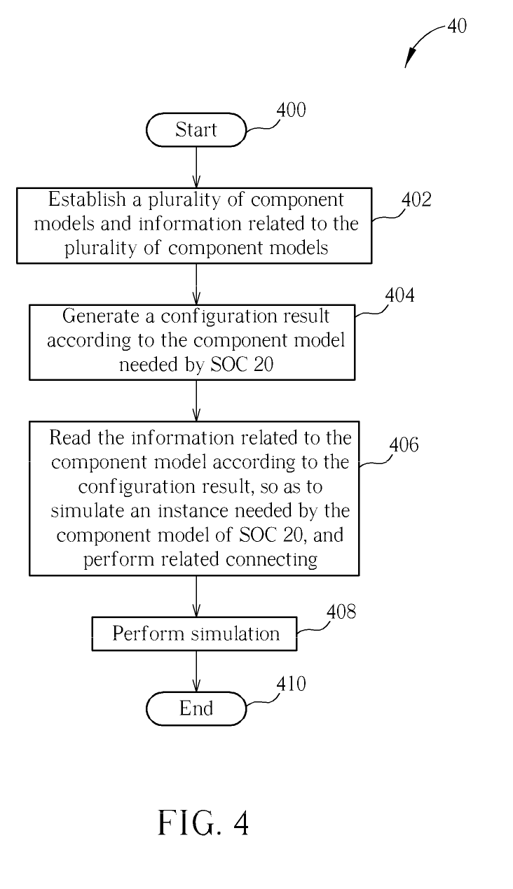

Please continue to refer to FIG. 4, which is a schematic diagram of a process 40 of a method for simulating SOC 20. The process 40 comprises following steps:

Step 400: Start.

Step 402: Establish a plurality of component models and information related to the plurality of component models.

Step 404: Generate a configuration result according to the component model needed by SOC 20.

Step 406: Read the information related to the component model according to the configuration result, so as to simulate an instance needed by the component model of SOC 20, and perform related connecting.

Step 408: Perform simulation.

Step 410: End.

Detailed operations of the process 40 are disclosed in aforementioned description of the virtual platform 10, and are not further explained herein for brevity.

To sum up, in the present invention, when the user wants to establish a new virtual platform, the user only needs to configure related configurations in the configuration module, such that the top module can generate the virtual platform required by the user. If there is a new component module needed by the new-generated virtual platform, the present invention can generate a new component model in the component module according to the aforementioned method of adding a new component model, and then configure related configurations in the configuration module, such that the top module can re-generate the virtual platform required by the user. Using such method for simulating a new virtual platform, the present invention can achieve configurable and extendable features, to accomplish the desired purpose.

Those skilled in the art will readily observe that numerous modifications and alterations of the device and method may be made while retaining the teachings of the invention.

What is claimed is:

1. A platform for simulating a chip comprising:
a component module, for storing a plurality of component models and information related to the plurality of component models;
a configuration module, for generating a configuration result according to a component model needed by the chip; and
a top module, coupled to the component module and the configuration module, for reading information related to the component model from the component module according to the configuration result so as to simulate the chip.

2. The platform of claim 1, wherein the information related to the plurality of component models comprises a name and a connecting method of the plurality of component models.

3. The platform of claim 2, wherein the plurality of component models are built with classes of C++.

4. The platform of claim 2, wherein the component module is an extendable module, and a new component model of the component module is compiled as a dynamic library file and is stored in a specified directory.

5. The platform of claim 4, wherein, when simulating the system-on-chip, the top module reads the dynamic library file in the specified directory, to obtain the new component model, and generates an instance of the new component model by dynamically loading.

6. The platform of claim 5, wherein the top module generates the instance of the new component model by an extending function.

7. The platform of claim 1, wherein the component model is a processor.

8. The platform of claim 1, wherein the component model is a timer.

9. A method for simulating a chip comprising:
establishing a plurality of component models and information related to the plurality of component models;
generating a configuration result according to a component model needed by the chip; and
reading information related to the component models from the plurality of component models according to the configuration result, so as to simulate the chip.

10. The method of claim 9, wherein the information related to the plurality of component models comprises a name and a connecting method of the plurality of component models.

11. The method of claim 10, wherein the plurality of component models are built with classes of C++.

12. The method of claim 10, wherein the plurality of component models are extendable, and a new component model is compiled as a dynamic library file and is stored in a specified directory.

13. The method of claim 12, wherein, when simulating the chip, the method is related to read the dynamic library file in the specified directory, to obtain the new component model, and is related to generate an instance of the new component model by dynamically loading.

14. The method of claim 13, wherein generating the instance of the new component model by the dynamic loading method is related to generate the instance of the new component model by an extending function.

15. The method of claim 9, wherein the component model is a processor.

16. The method of claim 9, wherein the component model is a timer.
